(19) United States
(12) Patent Application Publication
(10) Pub. No.: US 2018/0052309 A1
(43) Pub. Date: Feb. 22, 2018

(54) METHOD FOR EXPANDING FIELD OF VIEW OF HEAD-MOUNTED DISPLAY DEVICE AND APPARATUS USING THE SAME

(71) Applicant: ELECTRONICS AND TELECOMMUNICATIONS RESEARCH INSTITUTE, Daejeon (KR)

(72) Inventors: Gwang-Soon LEE, Daejeon (KR); Ho-Min EUM, Daejeon (KR); Eung-Don LEE, Daejeon (KR)

(21) Appl. No.: 15/673,042

(22) Filed: Aug. 9, 2017

(30) Foreign Application Priority Data
Aug. 19, 2016 (KR) 10-2016-0105429

(51) Int. Cl. G02B 13/16; G02B 3/00

(52) U.S. Cl. CPC G02B 13/16; G02B 3/0006

(57) ABSTRACT

Disclosed herein are a method for expanding a field of view of a head-mounted display device and an apparatus using the method. The method for expanding a field of view of a head-mounted display device projects a virtual image onto an eye of a user who wears the head-mounted display device. The method includes displaying an image using a curved display and a curved optical lens, and enlarging a virtual image corresponding to the image and projecting an enlarged virtual image at a location farther away from the eye of the user than the curved display using the curved optical lens, wherein the curved optical lens is located closer to the eye of the user than the curved display.

### CROSS REFERENCE TO RELATED APPLICATION

This application claims the benefit of Korean Patent Application No. 10-2016-0105429, filed Aug. 19, 2016, which is hereby incorporated by reference in its entirety into this application.

### BACKGROUND OF THE INVENTION

### 1. Technical Field

The present invention relates generally to technology for expanding the field of view of a Head-Mounted Display (HMD) device and, more particularly, to technology for enhancing the field of view in which an image is capable of being viewed through pupils when a user views a virtual reality (VR) image via a head-mounted display device.

### 2. Description of the Related Art

A Head-Mounted Display (HMD) device, which is a personal terminal used when a virtual-reality service is provided, has evolved to maximize the sense of immersion and the sense of reality felt by a user via the display device.

Generally, a head-mounted display device is composed of a display for displaying an image and an optical lens for creating a virtual image for the image displayed on the display and projecting the virtual image onto the user's eyes. In order to maximize the sense of immersion and the sense of reality of the head-mounted display device, the field of view in which the pupils of the user can view a screen must be expanded. For this function, the size of the display for displaying an image must be increased, and the diameter or refractive index of the optical lens must be increased, and thus image magnification must be increased. However, due to deterioration related to aberration characteristics, there is a limitation to the extent to which an optical lens can be changed, namely, increasing the thickness of the optical lens to increase the image magnification.

Further, since there is a limitation in changing an optical lens, a type of head-mounted display device in which a microlens array is utilized as an optical lens is also proposed. However, if individual virtual images created by the microlens array for integral imaging overlap each other, the size of an overlapping virtual image is reduced, thus deteriorating the sense of immersion. That is, there is a disadvantage in that when a microlens array is used as an optical lens, image magnification is lower than when using a single lens. In connection with this, Korean Patent No. 10-1615828 (Date of Registration: Apr. 20, 2016) discloses a technology related to “Method to enhance the viewing angle in the integral imaging display system using a mask panel.”

### SUMMARY OF THE INVENTION

Accordingly, the present invention has been made keeping in mind the above problems occurring in the prior art, and an object of the present invention is to expand the field of view of a viewer by improving a flat panel display and an optical lens in a head-mounted display device.

Another object of the present invention is to maximize a sense of immersion and a sense of reality provided by a head-mounted display device to a viewer.

A further object of the present invention is to provide a virtual-reality service having low viewing fatigue by providing a virtual image having low distortion to a viewer who wears a head-mounted display device.

In accordance with an aspect of the present invention to accomplish the above objects, there is provided a method for expanding a field of view of a head-mounted display device, the method projecting a virtual image onto an eye of a user who wears the head-mounted display device, the method including displaying an image using a curved display and a curved optical lens; and enlarging a virtual image corresponding to the image and projecting an enlarged virtual image at a location farther away from the eye of the user than the curved display using the curved optical lens, wherein the curved optical lens is located closer to the eye of the user than the curved display.

The curved optical lens may be implemented as a curved microlens array and is configured to display an image based on integral imaging.

Projecting the enlarged virtual image may be configured to enlarge the virtual image by combining respective magnifications of a positive meniscus lens and a microlens that constitute the curved microlens array.

The curved microlens array may be configured such that multiple lenses, corresponding to a form in which the positive meniscus lens and the microlens are combined with each other in consideration of optical characteristics, are arranged along a curved surface, wherein a convex surface of the microlens faces the eye of the user.

Both the curved display and the curved optical lens may be arranged such that concave surfaces thereof face the eye of the user.

The magnification of the positive meniscus lens may be a value obtained by dividing a distance from the positive meniscus lens to a virtual image, formed by the positive meniscus lens, by a distance from the positive meniscus lens to the curved display, and the magnification of the microlens corresponds to a value obtained by dividing a distance from the microlens to a virtual image, formed by the microlens, by a distance from the microlens to the curved display.

The curved microlens array may be configured to create multiple virtual images in which projection distortion, occurring when the virtual images overlap each other through multiple lenses arranged along the curved surface, is minimized, and then to create the virtual image corresponding to the image by respectively projecting the multiple virtual images.

In accordance with another aspect of the present invention to accomplish the above objects, there is provided a head-mounted display device having an expanded field of view, including a curved display configured to output an image to be provided as a virtual image to a user; and a curved optical lens located closer to an eye of the user than the curved display and configured to enlarge a virtual image corresponding to the image and project an enlarged virtual image at a location farther away from the eye of the user than the curved display.

The curved optical lens may be implemented as a curved microlens array and may be configured to project an image based on integral imaging.

The curved microlens array may be configured to enlarge the virtual image by combining respective magnifications of a positive meniscus lens and a microlens that constitute the curved microlens array.

The curved microlens array may be configured such that multiple lenses, corresponding to a form in which the positive meniscus lens and the microlens are combined with each other in consideration of optical characteristics, are arranged along a curved surface, wherein a convex surface of the microlens faces the eye of the user.

Both the curved display and the curved optical lens may be arranged such that concave surfaces thereof face the eye of the user.

The magnification of the positive meniscus lens may be a value obtained by dividing a distance from the positive meniscus lens to a virtual image, formed by the positive meniscus lens, by a distance from the positive meniscus lens to the curved display, and the magnification of the microlens corresponds to a value obtained by dividing a distance from the microlens to a virtual image, formed by the microlens, by a distance from the microlens to the curved display.

The curved microlens array may be configured to create multiple virtual images in which projection distortion, occurring when the virtual images overlap each other through multiple lenses arranged along the curved surface, is minimized, and then to create the virtual image corresponding to the image by respectively projecting the multiple virtual images.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating an example of a head-mounted display device using a single lens as an optical lens;

FIG. 2 is a diagram illustrating an example of a head-mounted display device using an optical lens implemented as a microlens array;

FIG. 3 is a diagram illustrating an example of the microlens illustrated in FIG. 2;

FIG. 4 is a diagram illustrating a head-mounted display device having an expanded field of view according to an embodiment of the present invention;

FIGS. 5 to 7 are diagrams illustrating examples of lenses constituting the curved microlens array illustrated in FIG. 4;

FIG. 8 is an operation flowchart illustrating a method for expanding the field of view of a head-mounted display device according to an embodiment of the present invention; and

FIG. 9 is a diagram illustrating an example in which a viewer wears a head-mounted display device according to the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

Hereinafter, preferred embodiments of the present invention will be described in detail with reference to the attached drawings.

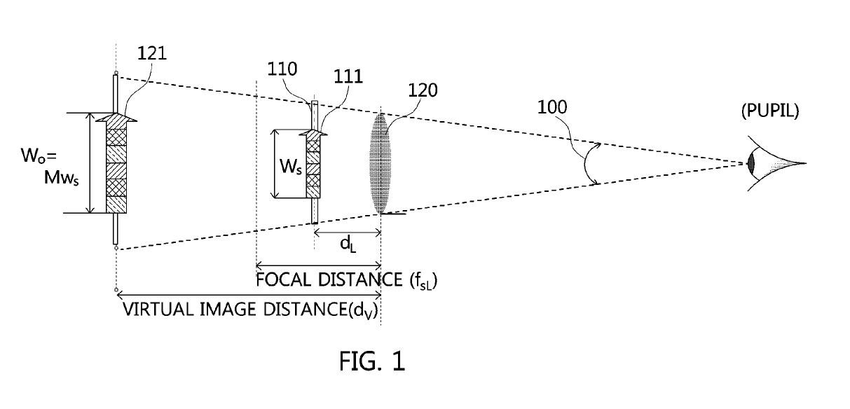

FIG. 1 is a diagram illustrating an example of a head-mounted display device using a single lens as an optical lens.

Referring to FIG. 1, the head-mounted display device using a single lens as an optical lens basically includes a flat panel display 110 and an optical lens 120.

Here, the flat panel display 110 may display an image 111, and the optical lens 120 may create a virtual image 121 from the image 111 displayed on the flat panel display 110 and may project the virtual image 121 onto the eye of a viewer. Here, the optical lens 120 may allow the virtual image projected onto the eye of the viewer who wears the head-mounted display device to be viewed as if the virtual image were located behind the flat panel display 110, and may function to enlarge the virtual image.

Referring to FIG. 1, it can be seen that the focal length (distance) f_{SL} of the optical lens 120 is implemented to be longer than the interval d_{L} between the flat panel display 110 and the optical lens 120. By means of this implementation, the optical lens 120 acts in a virtual mode, thus enabling the virtual image 121 created by enlarging the image 111 to be viewed behind the flat panel display 110.

Here, a magnification M, which is the factor by which the image 111 is enlarged by the optical lens 120, may be generally calculated using the following Equation (1):

M=−d_{V}/d_{L} (1)

where d_{V} may denote the distance between the optical lens 120 and the virtual image 121, and “-” may mean that the projected image is a virtual image.

Therefore, it can be seen that, when the size of the image 111 displayed on the flat panel display 110 illustrated in FIG. 11 is Wₛ, the size of the virtual image 121 is increased to W₀ due to the magnification M.

Here, in order to maximize the sense of immersion and the sense of reality in a head-mounted display device such as that illustrated in FIG. 1, the viewing angle 100 at which the pupil of the viewer is capable of viewing the screen must be increased.

Here, when the size of the flat panel display 110 is increased and the diameter or the refractive index of the optical lens 120 is changed to a larger value, the image magnification M may be increased, thus increasing the viewing angle 100. However, there may be a limitation in increasing the thickness of the optical lens or in changing the refractive index due to deterioration related to optical aberration characteristics.

Here, “optical aberration” means deviation of images from an ideal image of the optical lens, wherein if optical aberration characteristics are deteriorated, it may be difficult to provide a high-quality image to the viewer (user) who wears the head-mounted display device.

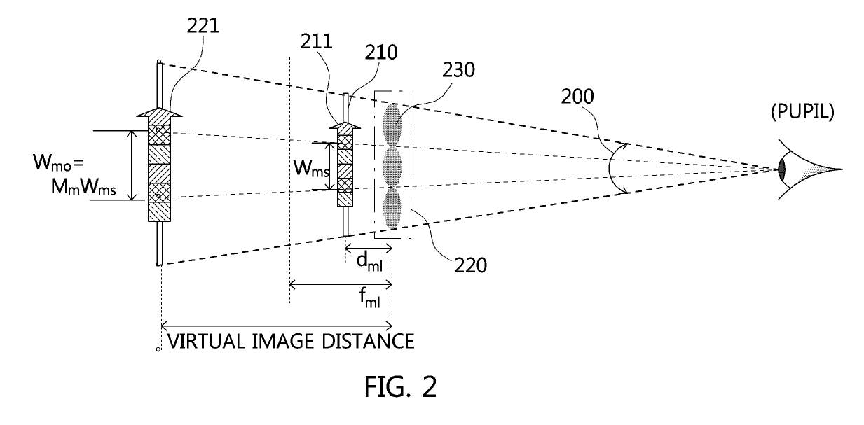

FIG. 2 is a diagram illustrating an example of a head-mounted display device using an optical lens implemented as a microlens array.

Referring to FIG. 2, the head-mounted display device using an optical lens implemented as a microlens array 220 may expand a viewing angle 200 of a viewer who wears the head-mounted display device by utilizing the microlens array 220 in which multiple microlenses 230 having the same diameter are arranged.

Although only three microlenses 230 are illustrated in the microlens array 220 shown in FIG. 2, the head-mounted display device may also be implemented by increasing the number of microlenses 230 to further widen the viewing angle 200.

Therefore, the head-mounted display device illustrated in FIG. 2 may be provided with a wider viewing angle 200 without changing the thickness of the optical lens, thus being advantageous in that it overcomes deterioration related to optical aberration characteristics.

Further, when integral imaging is applied to a flat panel display 210, a stereoscopic image may be reproduced, and the problem of visual fatigue may be reduced through the adjustment of a focal point.

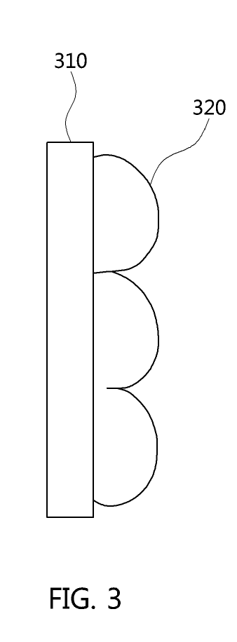

The microlenses 230 used in FIG. 2 may be generally implemented in a plano-convex type, as illustrated in FIG. 3.

Here, “plano” may correspond to a plane 310 shown in FIG. 3, and “convex” may correspond to a convex surface 320 shown in FIG. 3. That is, one surface of each microlens 230 may be implemented as the plane 310, and the other surface thereof may be implemented as the convex surface 320, thus enabling light to be refracted.

However, the image magnification of the microlens array 220 illustrated in FIG. 2 is determined by the magnification Mm of each microlens 230. However, for images based on integral imaging technology, virtual images created by the multiple microlenses 230 overlap each other, and thus the size of an image projected onto the eye of the viewer (user) who wears the head-mounted display device may be slightly decreased. That is, there may be a disadvantage in that when the microlens array 220 is used as the optical lens of the head-mounted display device, the image magnification of the microlens array 220 becomes lower than the image magnification of the head-mounted display device that uses the single lens, as shown in FIG. 1.

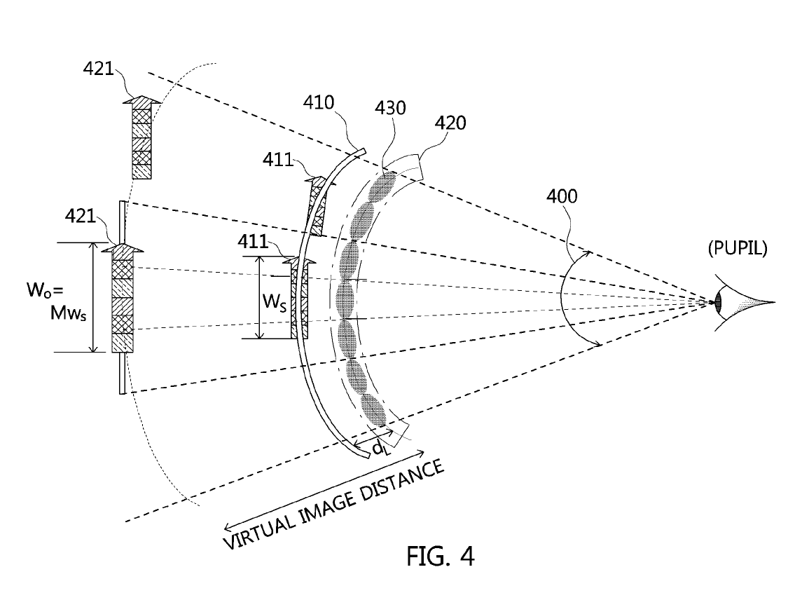

FIG. 4 is a diagram illustrating a head-mounted display device having an expanded field of view according to an embodiment of the present invention.

Referring to FIG. 4, it can be seen that the head-mounted display device having an expanded field of view according to an embodiment of the present invention widens a viewing angle 400 using a curved display 410 and a curved optical lens 420, unlike the head-mounted display device illustrated in FIG. 1 or 2.

Hereinafter, the procedure in which a virtual-reality service having an expanded field of view is provided using the head-mounted display device illustrated in FIG. 4 will be described.

First, an image 411 to be provided as a virtual image to a user via the curved display 410 is output, that is, displayed.

Here, the image may be an image based on integral imaging.

Since, as shown in FIG. 4, the image 411 is displayed via the display having the shape of a curved surface, the size of the surface that is viewed around the pupil of the viewer who wears the head-mounted display device may be increased, and thus the field of view may be expanded.

Integral imaging, which is initiated for the purpose of overcoming the disadvantage of glassless three-dimensional (3D) display technology, may provide not only horizontal aberration, but also vertical aberration, and may display a 3D image having continuous viewpoints within a uniform viewing angle.

Further, the curved optical lens 420 may be located closer to the eye of the user who wears the head-mounted display device than the curved display 410, and may enlarge a virtual image 421 corresponding to the image 411 and project the enlarged virtual image at a location farther away from the eye of the user than the curved display 410.

That is, the curved optical lens 420, the curved display 410, and the virtual image 421 may be sequentially located at increasing distance from the eye of the user (viewer) who wears the head-mounted display device.

Like the head-mounted display device shown in FIG. 1, the head-mounted display device shown in FIG. 4 is configured such that the focal distance of the curved optical lens 420 is longer than the interval between the curved display 410 and the curved optical lens 420, thus enabling the virtual image 421 created by the curved optical lens 420 to be projected onto the location behind the curved display 410.

Here, the curved optical lens 420 may be implemented as a curved microlens array.

The curved microlens array may enlarge the virtual image 421 by combining respective magnifications of a positive meniscus lens and microlenses which constitute the curved microlens array.

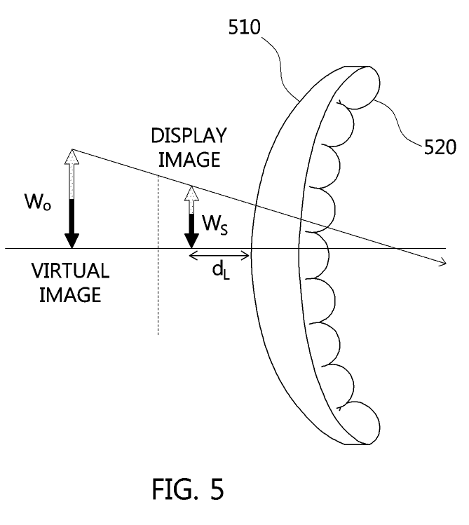

For example, when only microlenses are used, as in the case of the head-mounted display device shown in FIG. 2, a virtual image is enlarged using only the magnification corresponding to the microlenses, but the head-mounted display device shown in FIG. 4 may enlarge the virtual image 421 by increasing the magnification through the combined magnification of the positive meniscus lens and the microlenses. A description of respective magnifications of the positive meniscus lens and the microlenses will be made in detail with reference to FIGS. 5 to 7.

Here, the curved microlens array is configured such that multiple lenses, corresponding to a form in which the positive meniscus lens and the microlenses are combined with each other in consideration of optical characteristics, are arranged along a curved surface, wherein the convex surface of each microlens may face the eye of the user.

For example, in the multiple lenses, a side facing the curved display 410 may correspond to the positive meniscus lens, and the other side may correspond to the microlenses. Alternatively, as the occasion demands, in the multiple lenses, a side facing the curved display 410 may correspond to the microlenses, and the other side may correspond to the positive meniscus lens.

Here, the curved display 410 and the curved optical lens 420 may be arranged such that concave surfaces thereof face the eye of the user.

In this case, the magnification of the positive meniscus lens may be a value obtained by dividing the distance from the positive meniscus lens to a virtual image, formed by the positive meniscus lens, by the distance from the positive meniscus lens to the curved display 410.

Further, the magnification of each microlens may be a value obtained by dividing the distance from the microlens to the virtual image 421, formed by the microlens, by the distance from the corresponding microlens to the curved display 410.

In this way, the head-mounted display device shown in FIG. 4 may enlarge the virtual image 421 via the combination of the magnification of the positive meniscus lens with the magnification of the microlenses, thus being advantageous from the standpoint of image magnification compared to the head-mounted display devices shown in FIGS. 1 and 2.

The curved microlens array may create multiple virtual images in which projection distortion occurring due to the overlapping of virtual images via multiple lenses arranged along a curved surface is minimized, and may create an entire virtual image corresponding to the entire image by respectively projecting the multiple virtual images.

That is, the head-mounted display device shown in FIG. 2 creates an enlarged virtual image based on the image displayed on a flat panel display rather than a curved display. Accordingly, a problem arises in that overlapping portions occur between virtual images that are enlarged and projected by multiple microlenses constituting the microlens array, thus decreasing the size of the virtual image for the entire image, and in that distances from the pupil of the user to the multiple microlenses differ from each other, thus resulting in projection distortion. However, in the head-mounted display device according to the present invention, as illustrated in FIG. 4, a decrease in the size of a virtual image may be compensated for by additionally using the magnification of the positive meniscus lens, and projection distortion may be minimized because the distances from the pupil to the multiple lenses constituting the microlens array are equal to each other.

Therefore, an image in which projection distortion is minimized and in which the field of view is expanded may be provided to the viewer who wears the head-mounted display device, thus more vividly providing the sense of immersion and the sense of reality to the viewer.

FIGS. 5 to 7 are diagrams illustrating examples of lenses constituting the curved microlens array illustrated in FIG. 4.

Referring to FIG. 5, lenses constituting the curved microlens array of the curved optical lens illustrated in FIG. 4 may correspond to a form in which a positive meniscus lens 510 and microlenses 520 are combined with each other. Because two types of lenses are combined and used, image magnification may be increased more than in the case of the conventional head-mounted display devices illustrated in FIGS. 1 and 2.

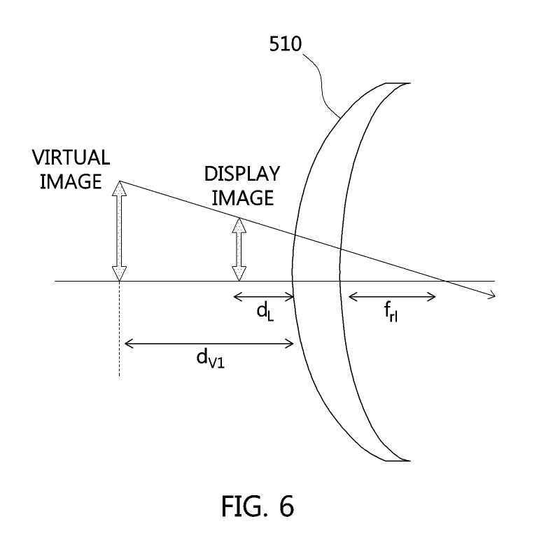

Here, assuming that the magnification of the positive meniscus lens 510 illustrated in FIG. 6 is Mᵣₗ, Mᵣₗ may be calculated using the following Equation (2):

Mᵣₗ=−d_{V1}/d_{L} (2)

where d_{V1} may denote the distance from the positive meniscus lens 510 to a virtual image, and d_{L} may denote the interval between a curved display and the positive meniscus lens 510.

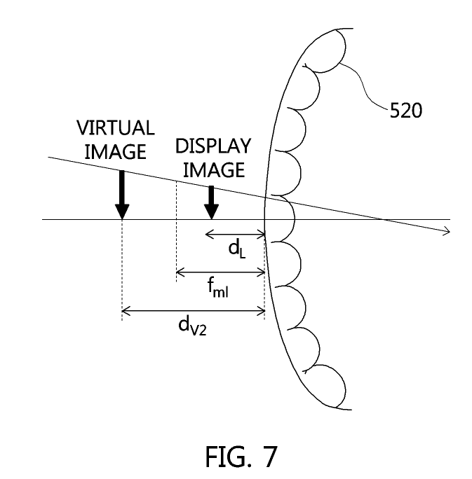

Further, assuming that the magnification of each microlens 520 shown in FIG. 7 is Mₘₗ, Mₘₗ may be calculated using the following Equation (3):

Mₘₗ=−d_{V2}/d_{L} (3)

where d_{V2} may denote the distance from the microlens 520 to a virtual image, and d_{L} may denote the interval between the curved display and the microlens 520.

Therefore, the magnification of the lenses constituting the curved microlens array of the curved optical lens shown in FIG. 5 may be determined by the combination of Mᵣₗ with Mₘₗ, and magnification may be increased by Mᵣₗ compared to the case of FIG. 2, where the microlens array is used as the optical lens.

In this case, the locations of lenses constituting the curved microlens array may be exchanged in consideration of the optical characteristics of the positive meniscus lens 510 and the microlenses 520. Here, the curved surface of the microlenses 520 may face the curved display.

Further, for the purpose of easily manufacturing the head-mounted display device, it may also be possible to implement the curved optical lens using only the positive meniscus lens 510 without utilizing the microlenses 520.

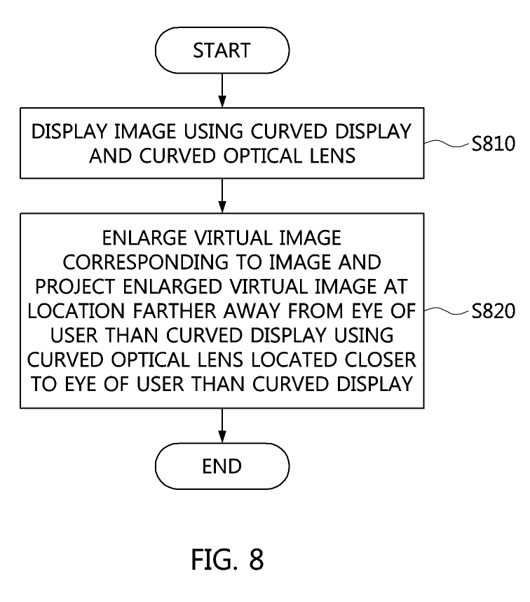

FIG. 8 is an operation flowchart illustrating a method for expanding the field of view of a head-mounted display device according to an embodiment of the present invention.

Referring to FIG. 8, the method for expanding the field of view of a head-mounted display device according to an embodiment of the present invention displays an image using a curved display and a curved optical lens in the method for projecting a virtual image to the eye of a user (viewer) who wears the head-mounted display device at step S810.

Here, since the image is displayed via the display having a curved shape, the size of the surface viewed around the pupil of the viewer who wears the head-mounted display device may be increased, whereby the field of view may be expanded.

Here, the curved optical lens may be implemented as a curved microlens array and may display an image based on integral imaging.

Integral imaging, which is initiated for the purpose of overcoming the disadvantage of glassless 3D display technology, may provide not only horizontal aberration, but also vertical aberration, and may display a 3D image having continuous viewpoints within a uniform viewing angle.

Further, the method for expanding the field of view of the head-mounted display device according to the embodiment of the present invention may enlarge a virtual image corresponding to an image and may project the enlarged virtual image at a location farther away from the eye of the user than the curved display using a curved optical lens, which is located closer to the eye of the user than the curved display, at step S820.

That is, the curved optical lens, the curved display, and the virtual image may be sequentially located at increasing distance from the eye of the user who wears the head-mounted display device.

Here, the head-mounted display device according to the present invention is configured such that the focal distance of the curved optical lens is longer than the interval between the curved display and the curved optical lens, similar to the conventional head-mounted display device shown in FIG. 1, thus enabling the virtual image created by the curved optical lens to be projected onto the location behind the curved display.

The curved microlens array may enlarge the virtual image by combining respective magnifications of a positive meniscus lens and microlenses which constitute the curved microlens array.

For example, when only microlenses are used, as in the case of the head-mounted display device shown in FIG. 2, a virtual image is enlarged using only the magnification corresponding to the microlenses, but the head-mounted display device according to the present invention may enlarge the virtual image by increasing the magnification through the combined magnification of the positive meniscus lens and the microlenses. A description of respective magnifications of the positive meniscus lens and the microlenses has been made above with reference to FIGS. 5 to 7.

Here, the curved microlens array is configured such that multiple lenses, corresponding to a form in which the positive meniscus lens and the microlenses are combined with each other in consideration of optical characteristics, are arranged along a curved surface, wherein the convex surface of each microlens may face the eye of the user.

For example, in the multiple lenses, a side facing the curved display may correspond to the positive meniscus lens, and the other side may correspond to the microlenses. Alternatively, as the occasion demands, in the multiple lenses, a side facing the curved display may correspond to the microlenses, and the other side may correspond to the positive meniscus lens.

Here, the curved display and the curved optical lens may be arranged such that concave surfaces thereof face the eye of the user.

In this case, the magnification of the positive meniscus lens may be a value obtained by dividing the distance from the positive meniscus lens to a virtual image, formed by the positive meniscus lens, by the distance from the positive meniscus lens to the curved display.

Further, the magnification of each microlens may be a value obtained by dividing the distance from the microlens to the virtual image, formed by the microlens, by the distance from the corresponding microlens to the curved display.

In this way, the head-mounted display device according to the present invention may enlarge the virtual image via the combination of the magnification of the positive meniscus lens with the magnification of the microlenses, thus being advantageous from the standpoint of image magnification compared to the head-mounted display devices shown in FIGS. 1 and 2.

The curved microlens array may create multiple virtual images in which projection distortion occurring due to the overlapping of virtual images via multiple lenses arranged along a curved surface is minimized, and may create an entire virtual image corresponding to the entire image by respectively projecting the multiple virtual images.

That is, the head-mounted display device shown in FIG. 2 creates an enlarged virtual image based on the image displayed on a flat panel display rather than a curved display. Accordingly, a problem arises in that overlapping portions occur between virtual images that are enlarged and projected by multiple microlenses constituting the microlens array, thus decreasing the size of the virtual image for the entire image, and in that distances from the pupil of the user to the multiple microlenses differ from each other, thus resulting in projection distortion. However, in the head-mounted display device according to the present invention, a decrease in the size of a virtual image may be compensated for by additionally using the magnification of the positive meniscus lens, and projection distortion may be minimized because the distances from the pupil to the multiple lenses constituting the microlens array are equal to each other.

Therefore, an image in which projection distortion is minimized and in which the field of view is expanded may be provided to the viewer who wears the head-mounted display device, thus more vividly providing the sense of immersion and the sense of reality to the viewer.

In this way, through the use of the method for expanding the field of view of the head-mounted display device according to the present invention, the flat panel display and the optical lens may be improved in the head-mounted display device, thus enabling the field of view of a viewer to be expanded.

Further, the sense of immersion and the sense of reality that are provided to a viewer by the head-mounted display device may be maximized.

Furthermore, there can be provided a virtual-reality service causing low viewing fatigue by providing a virtual image having low distortion to a viewer who wears the head-mounted display device.

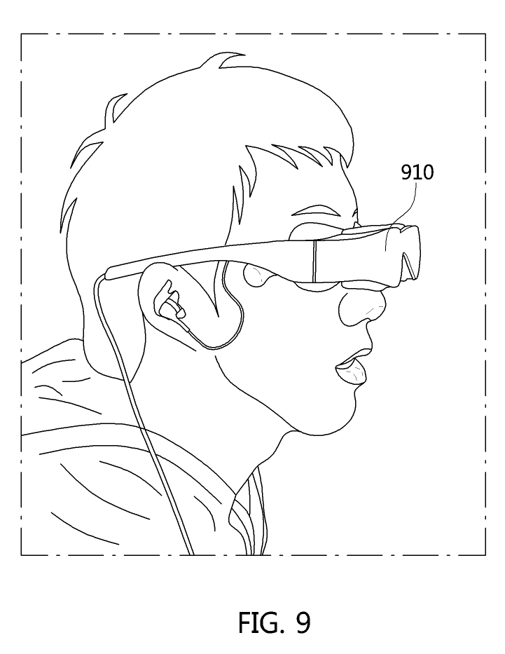

FIG. 9 is a diagram illustrating an example in which a viewer wears a head-mounted display device according to the present invention.

Referring to FIG. 9, the head-mounted display device according to the present invention may correspond to a shape in which a viewer wears the head-mounted display device on his or her face and is capable of viewing an image projected from the inside of the head-mounted display device, as shown in FIG. 9.

Here, the shape of the head-mounted display device is not limited to that shown in FIG. 9, but may be produced in various forms, as long as they enable a user to view a stereoscopic image corresponding to a virtual-reality service through the configuration of the present invention.

In accordance with the present invention, the field of view of a viewer may be expanded by improving a flat panel display and an optical lens in a head-mounted display device.

Further, the present invention may maximize the sense of immersion and the sense of reality provided by a head-mounted display device to a viewer.

Furthermore, the present invention may provide a virtual-reality service causing low viewing fatigue by providing a virtual image having low distortion to a viewer who wears a head-mounted display device.

As described above, in the method for expanding the field of view of a head-mounted display device and the apparatus using the method according to the present invention, the configurations and schemes in the above-described embodiments are not limitedly applied, and some or all of the above embodiments can be selectively combined and configured such that various modifications are possible.

What is claimed is:

1. A method for expanding a field of view of a head-mounted display device, the method projecting a virtual image onto an eye of a user who wears the head-mounted display device, the method comprising:
displaying an image using a curved display and a curved optical lens; and
enlarging a virtual image corresponding to the image and projecting an enlarged virtual image at a location farther away from the eye of the user than the curved display using the curved optical lens, wherein the curved optical lens is located closer to the eye of the user than the curved display.

2. The method of claim 1, wherein the curved optical lens is implemented as a curved microlens array and is configured to display an image based on integral imaging.

3. The method of claim 2, wherein projecting the enlarged virtual image is configured to enlarge the virtual image by combining respective magnifications of a positive meniscus lens and a microlens that constitute the curved microlens array.

4. The method of claim 3, wherein the curved microlens array is configured such that multiple lenses, corresponding to a form in which the positive meniscus lens and the microlens are combined with each other in consideration of optical characteristics, are arranged along a curved surface, wherein a convex surface of the microlens faces the eye of the user.

5. The method of claim 4, wherein both the curved display and the curved optical lens are arranged such that concave surfaces thereof face the eye of the user.

6. The method of claim 3, wherein the magnification of the positive meniscus lens is a value obtained by dividing a distance from the positive meniscus lens to a virtual image, formed by the positive meniscus lens, by a distance from the positive meniscus lens to the curved display, and the magnification of the microlens corresponds to a value obtained by dividing a distance from the microlens to a virtual image, formed by the microlens, by a distance from the microlens to the curved display.

7. The method of claim 4, wherein the curved microlens array is configured to create multiple virtual images in which projection distortion, occurring when the virtual images overlap each other through multiple lenses arranged along the curved surface, is minimized, and then to create the virtual image corresponding to the image by respectively projecting the multiple virtual images.

8. A head-mounted display device having an expanded field of view, comprising:
a curved display configured to output an image to be provided as a virtual image to a user; and
a curved optical lens located closer to an eye of the user than the curved display and configured to enlarge a virtual image corresponding to the image and project an enlarged virtual image at a location farther away from the eye of the user than the curved display.

9. The head-mounted display device of claim 8, wherein the curved optical lens is implemented as a curved microlens array and is configured to project an image based on integral imaging.

10. The head-mounted display device of claim 9, wherein the curved microlens array is configured to enlarge the virtual image by combining respective magnifications of a positive meniscus lens and a microlens that constitute the curved microlens array.

11. The head-mounted display device of claim 10, wherein the curved microlens array is configured such that multiple lenses, corresponding to a form in which the positive meniscus lens and the microlens are combined with each other in consideration of optical characteristics, are arranged along a curved surface, wherein a convex surface of the microlens faces the eye of the user.

12. The head-mounted display device of claim 11, wherein both the curved display and the curved optical lens are arranged such that concave surfaces thereof face the eye of the user.

13. The head-mounted display device of claim 10, wherein the magnification of the positive meniscus lens is a value obtained by dividing a distance from the positive meniscus lens to a virtual image, formed by the positive meniscus lens, by a distance from the positive meniscus lens to the curved display, and the magnification of the microlens corresponds to a value obtained by dividing a distance from the microlens to a virtual image, formed by the microlens, by a distance from the microlens to the curved display.

14. The head-mounted display device of claim 11, wherein the curved microlens array is configured to create multiple virtual images in which projection distortion, occurring when the virtual images overlap each other through multiple lenses arranged along the curved surface, is minimized, and then to create the virtual image corresponding to the image by respectively projecting the multiple virtual images.
